(19) United States
(12) Patent Application Publication
(10) Pub. No.: US 2010/0157779 A1
(43) Pub. Date: Jun. 24, 2010

(54) OBJECTIVE LENS DRIVE DEVICE

(75) Inventors: Koji Ieki, Osaka (JP); Hiroaki Kojima, Ehime (JP)

Correspondence Address: Dickinson Wright PLLC;James E. Ledbetter, Esq., International Square, 1875 Eye Street, N.W., Suite 1200, Washington, DC, 20006, US

(73) Assignee: MATSUSHITA ELECTRICINDUSTRIAL CO., LTD., Osaka (JP)

(21) Appl. No.: 12/160,530

(22) PCT Filed: Oct. 23, 2006
(86) PCT No.: PCT/JP2006/321018

§ 371 Date: Jul. 10, 2008

(30) Foreign Application Priority Data
Jan. 27, 2006 (JP) 2006-018305

(51) Int. Cl. G11B 7/00

(52) U.S. Cl. 369/112.23; G9B/7

(57) ABSTRACT

An objective lens drive device where a cushioning elastic body can be stably poured into a through-hole that is formed in a wire holder in which a suspension wire is inserted, and where the amount of the elastic body required is reduced. The through-hole that is formed in the wire holder (8) and in which the suspension wire (7) is inserted has a first elastic body receiving section (8a) formed on a lens holder (2) side, a second elastic body receiving section (8b) formed on a wire fixation member side so as to be adjacent to the first elastic body receiving section (8a), and a wire penetration hole (8c) for communicating the first elastic body receiving section (8a) and the second elastic body receiving section (8b) and having a smaller diameter than the first elastic body receiving section (8a).

### TECHNICAL FIELD

The present invention relates to an objective lens drive device for an optical pickup device or the like provided in a DVD player and the like, and specifically, to an objective lens drive device having a lens holder suspended via a plurality of suspension wires.

### BACKGROUND ART

In an objective lens drive device for an optical pickup device provided in a DVD player and the like, an objective lens is mounted in a lens holder. A plurality of suspension wires are fixed to the lens holder at one end of the wires and to a wire fixation member at the other end. The lens holder is thus displaceable in a focus direction at right angles to an optical disc and in a tracking direction as a radiating direction of the optical disc. Furthermore, according to Japanese Patent Laid-Open No. 7-225960 and the like, within a certain range of wires, the periphery of the wires is filled with a gel-like elastic body material to reduce the possible vibration of the wires.

FIG. 4 is a plan view showing an example of a conventional objective lens drive device.

An objective lens 1 is adhesively held by a lens holder 2. Ends of a plurality of suspension wires 7 are fixed to the lens holder 2 with solder or the like. The other ends of the suspension wires 7 are fixed to a wire holding section 12 with solder or the like.

FIG. 5 is a perspective of a wire holding section 12 in FIG. 4.

The wire holding section 12 is composed of a plate-like wire fixation member 14 that fixes the wires with solder and a wire holder 13 that holds the wire fixation member 14. Through-holes 13a are formed in the wire holder 13 so that the respective wires pass through the through-holes 13a. The peripheries of wire fixation sections 14a of the wire fixation member 14 are elastically deformable with respect to a buckling direction of the suspension wires 7 in order to reduce the possible buckling deformation of the suspension wires 7. A gel-like elastic body 15 is filled into the through-holes 13a in the wire holder 13 so as to contact the periphery of the suspension wires 7 and elastically deformed portions of the wire fixation member 14.

A contact length A over which the gel-like material contacts the suspension wires 7 is, for example, 3.5 mm. The elastic body 15 reduces the possible vibration of the suspension wires 7 and the wire fixation member 14. This inhibits the possible resonance of the objective lens drive device.

FIGS. 6 and 7 are characteristic diagrams of the frequencies of the objective lens driving device in a focusing direction and in a tracking direction. The focusing direction and the tracking direction both have a first resonance peak at 60 Hz. Furthermore, because of buckling of the suspension wires 7, unwanted resonance occurs at 650 Hz in the focusing direction and at 2.6 kHz in the tracking direction.

To reduce the costs of the objective lens drive device, it is desirable to reduce the amount of the elastic body used, which is expensive. Reduction of the contact length A of the elastic body to the suspension wires 7 can reduce the usage amount of the elastic body. However, this prevents the elastic body from contacting portions of the suspension wires 7 which are significantly deformed, thus increasing the first resonance peak. The increased resonance peak makes it difficult to control the objective lens 1 in the focusing direction and in the tracking direction.

To reduce the possible resonance caused by buckling deformation of the suspension wires 7, it is preferable to contact the elastic body with the peripheries of the wire fixation sections 14a of the wire fixation member 14. However, to allow the suspension wires 7 to penetrate the through-holes 13a in the wire holder 13, the through-holes 13a are not closed with respect to a direction in which the wire fixation member 14 is elastically deformed. This prevents the damping effect of the elastic body from being sufficiently exerted. The insufficient damping precludes the possible resonance caused by the buckling deformation of the wires from being sufficiently inhibited. This in turn prevents the objective lens 1 from following a disc surface and a disc groove.

Furthermore, according to the structure of the wire holder 13 in FIG. 5, the elastic body needs to be poured into the through-holes 13a through hole sections penetrated by the suspension wires 7, toward the wire fixation sections 14a of the wire fixation member 14. To stably inhibit the possible resonance, it is necessary to fill a sufficient amount of the elastic body into the through-hole 13a and the wire fixation sections 14a of the wire fixation member 14. However, since the elastic body has a high viscosity, highly accurate pouring conditions are required to achieve stable pouring. A failure to perform the operation of pouring the elastic body may result in defective products.

An object of the present invention is to provide an objective lens drive device that can solve the above-described problems.

### DISCLOSURE OF THE INVENTION

An objective lens drive device according to claim 1 of the present invention includes a lens holder holding an objective lens, a plurality of suspension wires coupled to the lens holder, a wire fixation member that holds the suspension wires and can elastically deform in a length direction of the wires, a wire holder having through-holes through which the respective plurality of suspension wire pass, and an elastic body filled into the through-holes in the wire holder around a periphery of the wires, wherein each of the through-holes in the wire holder includes a first elastic body receiving section formed closer to the lens holder, a second elastic body receiving section formed adjacent to the first elastic body receiving section and closer to the wire fixation member, and wire penetration holes through which the first elastic body receiving section and the second elastic body receiving section are in communicate with each other and each of which has a smaller diameter than the first elastic body receiving section.

With this configuration, the first elastic body receiving section and the second elastic body receiving section are connected together through the wire penetration holes each having an area appropriate to avoid interfering with the movement range of the corresponding suspension wire in order to allow the suspension wire to penetrate to the wire fixation member. However, avoiding filling a cushioning member into the wire penetration hole sections reduces the range within which the cushioning member is filled, enabling a significant reduction in the amount of cushioning member used. The amount of displacement caused by elastic deformation in a focusing direction and a tracking direction of the suspension wires is much smaller in the wire penetration hole sections than in the first elastic body receiving section. Thus, even when the cushioning member is not filled into the wire penetration holes, the damping effect of the suspension wires is sufficiently secured. This avoids affecting the inhibition of the first resonance of the objective lens drive device.

According to claim 2 of the present invention, in the objective lens drive device according to claim 1, each of the through-holes in the wire holder is constructed in which the first elastic body receiving section and the second elastic body receiving section are divided by a wall perpendicular to the suspension wires, and the wire penetration holes through which the respective wires can be substantially barely inserted are formed in the wall so that the first elastic body receiving section and the second elastic body receiving section are in communication with each other.

With this arrangement, the first elastic body receiving section and the second elastic body receiving section are connected together through the wire penetration holes each of which is narrower than the elastic body receiving section. Thus, the wall is provided with respect to a direction in which the suspension wire holding section may vibrate. The second elastic body receiving section is closed with respect to a direction in which the wire fixation member is elastically deformed. Consequently, the cushioning elastic body can sufficiently inhibit the possible vibration of the wire fixation member. This enables a reduction in the possible unwanted resonance of the objective lens drive device caused by buckling of the suspension wires.

According to claim 3 of the present invention, in the objective lens drive device according to claim 1, among the first elastic body receiving section, the second elastic body receiving section, and the wire penetration holes through which the suspension wires are inserted, the cushioning elastic body is filled into the first elastic body receiving section and the second elastic body receiving section, while the cushioning elastic body is not filled into the wire penetration holes.

According to claim 4 of the present invention, in the objective lens drive device according to claim 1, each of the through-holes in the wire holder has, at opposite ends, a first pouring section through which the elastic body is poured into the first elastic body receiving section and a second pouring section through which the elastic body is poured into the second elastic body receiving section.

With this arrangement, the cushioning elastic body can be poured individually into the first elastic body receiving section and the second elastic body receiving section. The stable filling of the elastic body makes it possible to stabilize the frequency characteristic of the objective lens drive device. The operation of pouring the cushioning member is also facilitated.

The above-described configuration can exert a high cushioning performance even with the reduced amount of the cushioning elastic body filled.

### BRIEF DESCRIPTION OF THE DRAWINGS

FIG. 1 is a perspective view of an objective lens drive device according to the present invention;

FIG. 2 is a perspective view of a wire holder and a wire fixation member according to an embodiment of the present invention;

FIG. 3 is a sectional view of elastic body receiving sections in an assembly of the wire holder, the wire fixation member, and suspension wires;

FIG. 4 is a plan view of a conventional objective lens drive device;

FIG. 5 is a perspective view of a wire holding section in the conventional example;

FIG. 6 is a graph of frequency characteristic in a focusing direction in the conventional example;

FIG. 7 is a graph of frequency characteristic in a tracking direction in the conventional example;

FIG. 8 is a graph of frequency characteristic in a focusing direction in an embodiment of the present invention; and

FIG. 9 is a graph of frequency characteristic in a tracking direction in the embodiment of the present invention.

### BEST MODE FOR CARRYING OUT THE INVENTION

An objective lens drive device according to the present invention will be described below on the basis of embodiments of the present invention.

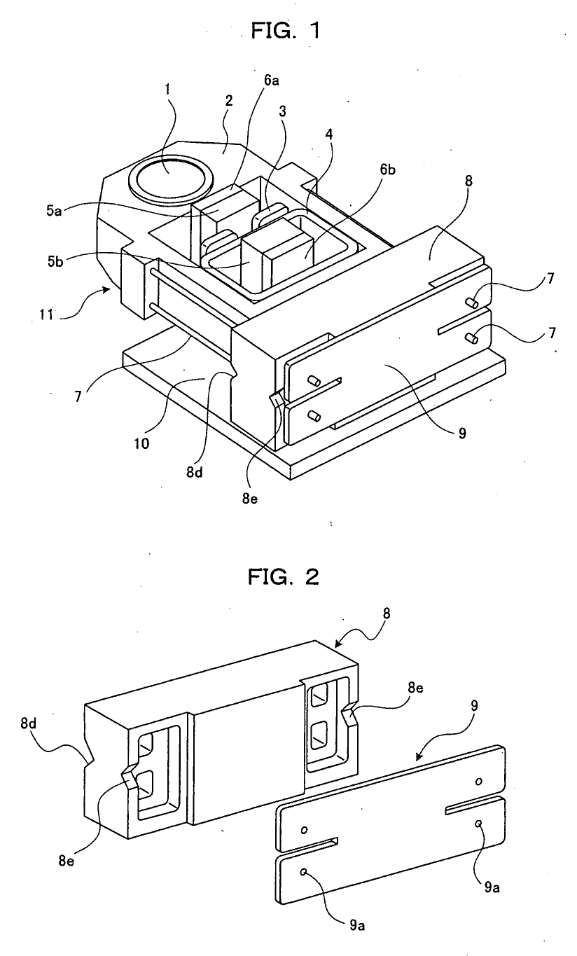

FIG. 1 is a perspective view of an objective lens drive device for an optical pickup device.

The optical pickup device is mounted in an optical disc recording and reproducing apparatus such as DVD or CD. A focusing direction corresponds to a direction at right angles to a surface of a disc. A tracking direction corresponds to a radial direction of the disc. Furthermore, a tangential direction corresponds to a direction at right angles to the focusing direction and the tracking direction. An objective lens 1 is adhesively fixed to a lens holder 2 so that the disc is irradiated with a light beam through the objective lens 1. A focusing coil 3 is made up of a coil rolled into a rectangular shape and adhesively fixed to the lens holder 2 with an axis thereof set in the focusing direction. Two tracking coils 4 are each made up of a coil rolled into a rectangular shape and adhesively fixed to an outer periphery of one long side portion of the focusing coil with an axis set in the tangential direction.

Together with coil ends of the focusing coil 3 and the tracking coil 4, one end of each of four suspension wires 7 is fixed to the lens holder with solder or the like. The other end of each suspension wire 7 is fixed to a wire fixation member 9 shaped like a printed circuit board with solder or the like. The suspension wires 7 are elastically deformed to allow a movable member 11 made up of the objective lens 1, the lens holder 2, the focusing coil 3, and the tracking coils 4 to be displaced in the focusing direction and the tracking direction.

Magnets 5a and 5b are arranged in proximity to the focusing coil 3 and the tracking coils 4. Current is supplied to the focusing coil 3 and the tracking coils 4 through the wire fixation member 9 and the suspension wires 7 to generate a driving force required to operate the movable member 11. By controlling driving forces in the focusing direction and in the tracking direction, it is possible to allow the objective lens to follow side-runout or decentering, which may occur during rotation of the disc. The wire fixation member 9 is fixed to a wire holder 8 which is fixed to a base 10. The magnets 5a and 5b are fixed to yokes 6a and 6b which are fixed to the base 10.

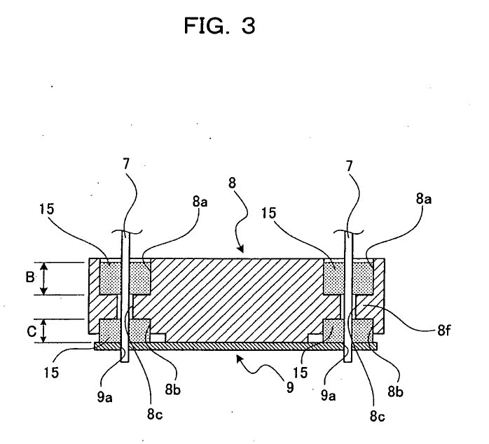

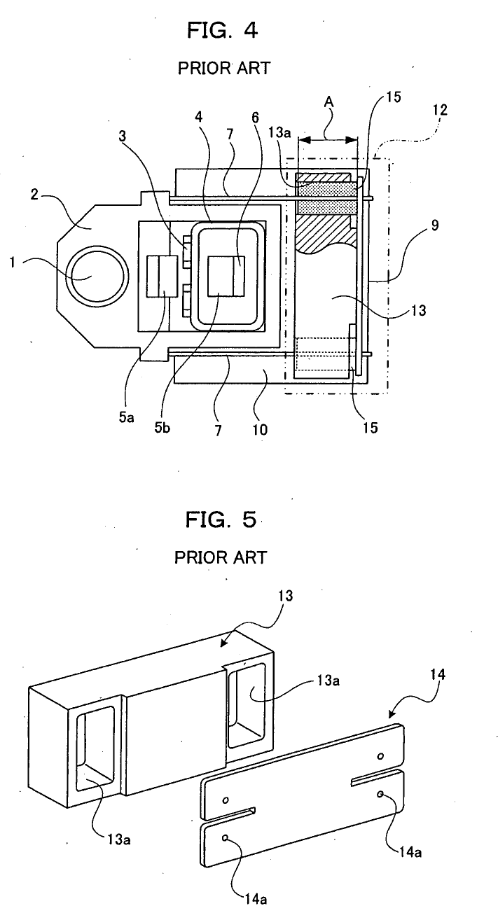

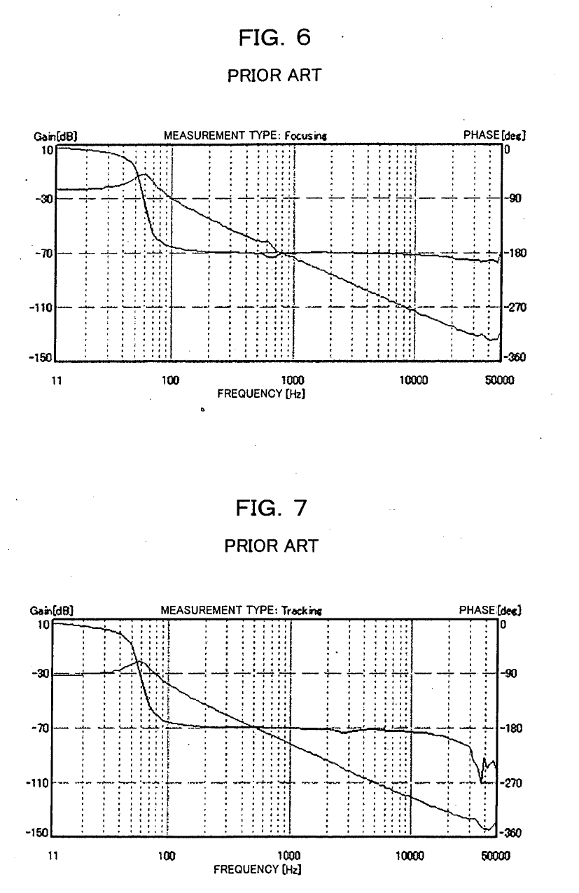

FIG. 2 is a perspective view of the wire holder 8 and the wire fixation member 9. FIG. 3 is a sectional view of an elastic body receiving section in an assembly of the wire holder 8, the wire fixation member 9, and the suspension wires 7.

The periphery of a wire fixation section 9a of the wire fixation member 9 is elastically deformable with respect to a buckling direction of the suspension wires 7 in order to reduce the possible buckling deformation of the suspension wires 7. Wire penetration hole sections 8c are formed in the wire holder 8 at positions through which the suspension wires 7 are inserted.

Moreover, a first elastic body receiving section 8a is formed in the wire holder 8 on a lens holder 2-side of the wire holder 8 adjacent to the wire penetration holes 8c. A second elastic body receiving section 8b is formed in the wire holder 8 on a wire fixation member 9-side of the wire holder 8 adjacent to the wire penetration holes 8c. In the present embodiment, the wire penetration holes 8c are formed independently for the respective suspension wires 7. The two first elastic body receiving sections 8a are each formed on the lens holder 2-side of the wire holder 8 for the vertically adjacent suspension wires 7. The two second elastic body receiving sections 8b are formed on the wire fixation member 9-side of the wire holder 8 for the vertically adjacent suspension wires 7.

That is, the first elastic receiving section 8a and the second elastic body receiving section 8b are separated from each other by a wall 8f perpendicular to the suspension wires 7. The first elastic receiving section 8a and the second elastic body receiving section 8b are allowed to communicate with each other by means of the wire penetration holes 8c, each of which is formed in the wall 8f and has a small diameter. More specifically, the small diameter of each of the wire penetration hole sections 8c is such that each of the wires 7 can be almost barely inserted through the wire penetration hole section 8c.

In association with the first elastic body receiving section 8a, in the wire holder 8, first notches 8d as first pouring sections through which the elastic body is poured into the first elastic body receiving section 8a, and the second elastic body receiving section 8b, and second notches 8e as second pouring sections through which the elastic body is poured into the second elastic body receiving section 8b are formed, as shown in FIG. 2.

Through the first notch 8d and second notch 8e thus formed, the elastic body can be easily stably filled into the first and second elastic body receiving sections 8a and 8b.

Furthermore, an elastic body 15 can be filled individually into the first and second notches 8d and 8e through the first and second notches 8d and 8e. This reduces the depth of the elastic body to be poured, allowing the elastic body to be stably filled.

Moreover, even though the elastic body 15 is filled into the first and second elastic body receiving sections 8a and 8b, the elastic body 15 is not filled into the wire penetration hole sections 8c. This enables a reduction in the required amount of elastic body 15 compared to the conventional art.

A contact length B over which the elastic body 15 contacts the suspension wires 7 in the first elastic body receiving section 8a is, for example, 1.5 mm. A contact length C is, for example, 0.5 mm over which the elastic body 15 contacts the suspension wires 7 in the second elastic body receiving section 8b and up to a top surface of the wire fixation member 9. Thus, the elastic body 15 is not filled within the range of the wire penetration hole sections 8c. This reduces the amount of elastic body 15 used.

Thus, filling the cushioning elastic body 15 into the first elastic body receiving section 8a causes the elastic body 15 to contact the periphery of the suspension wires 7. The suspension wires 7 in the wire penetration hole sections 8c are located closer to a wire fixed side and involve a smaller elastic deformation amount. Thus, even though the wire penetration hole sections 8c are not filled with the elastic body 15, the damping effect for the wires is less affected. The elastic body 15 filled into the first elastic body receiving section 8a sufficiently inhibits the first resonance of the objective lens drive device.

Filling the cushioning elastic body 15 into the second elastic body receiving section 8b causes the elastic body 15 to contact the periphery of the elastically deformable wire fixation section 9a of the wire fixation section 9. The area of the wire penetration hole sections 8c is sufficiently smaller than that of the second elastic body receiving section 8b. Thus, the second elastic body receiving section 8b can be considered to be closed with respect to a direction in which the wire fixation section 9a is elastically deformed. The damping effect of the elastic body can thus be sufficiently exerted. The sufficiently damped wire fixation section 9a enables a reduction in the possible unwanted resonance of the objective lens drive device caused by the buckling of the suspension wires.

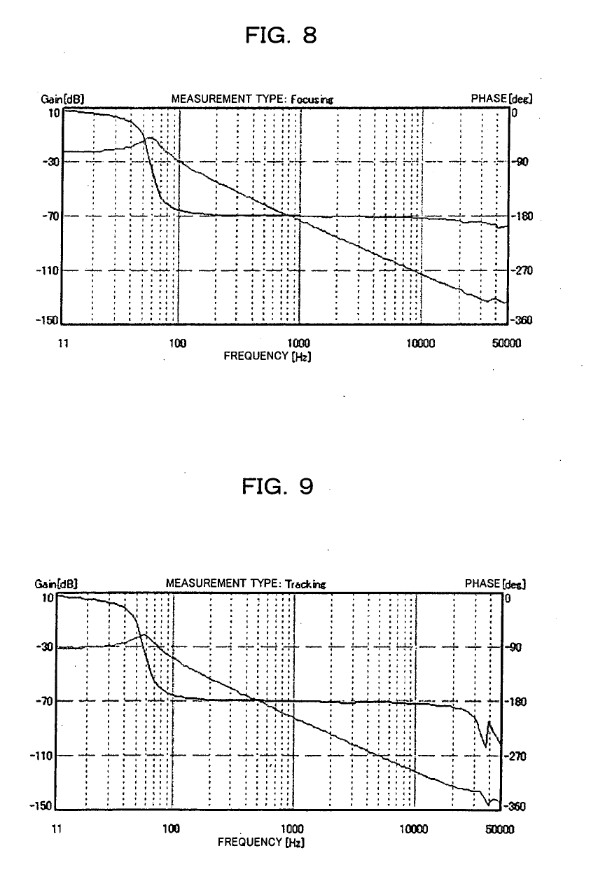

FIGS. 8 and 9 are graphs of frequency characteristic in the focusing and tracking directions of the objective lens drive device according to the present invention. Both in the focusing direction and in the tracking direction, the objective lens drive device exhibits a first resonance characteristic equivalent to that in the conventional art. The figures show that the unwanted resonance, caused by the buckling of the suspension wires 7, was inhibited at 650 Hz in the focusing direction and at 2.6 kHz in the tracking direction. This application is based upon and claims the benefit of priority of Japanese Patent Application No. 2006-018305 filed on Jan. 27, 2006, the contents of which are incorporated herein by reference in its entirety.

### INDUSTRIAL APPLICABILITY

The present invention can contribute to improving the performance of various optical disc drive devices using objective lens drive devices.

1. An objective lens drive device comprising a lens holder holding an objective lens, a plurality of suspension wires coupled to the lens holder, a wire fixation member that holds the suspension wires and can elastically deform in a length direction of the wires, a wire holder having through-holes through which the respective plurality of suspension wires pass, and an elastic body filled into the through-holes in the wire holder around a periphery of the wires,
wherein each of the through-holes in the wire holder comprises:
a first elastic body receiving section formed closer to the lens holder;
a second elastic body receiving section formed adjacent to the first elastic body receiving section and closer to the wire fixation member; and
wire penetration holes through which the first elastic body receiving section and the second elastic body receiving section are in communication with each other and each of which has a smaller diameter than the first elastic body receiving section.

2. The objective lens drive device, wherein each of the through-holes in the wire holder is constructed in which the first elastic body receiving section and the second elastic body receiving section are divided by a wall perpendicular to the suspension wires, and the wire penetration holes through which the respective wires can be substantially barely inserted are formed in the wall so that the first elastic body receiving section and the second elastic body receiving section are in communication with each other.

3. The objective lens drive device according to claim 1, wherein among the first elastic body receiving section, the second elastic body receiving section, and the wire penetration holes through which the suspension wires are inserted, the cushioning elastic body is filled into the first elastic body receiving section and the second elastic body receiving section, while the cushioning elastic body is not filled into the wire penetration holes.

4. The objective lens drive device according to claim 1, wherein each of the through-holes in the wire holder has, at opposite ends, a first pouring section through which the elastic body is poured into the first elastic body receiving section and a second pouring section through which the elastic body is poured into the second elastic body receiving section.
